(19) United States
(12) Patent Application Publication
(10) Pub. No.: US 2024/0358580 A1
(43) Pub. Date: Oct. 31, 2024

(54) SELF-BALANCING MASSAGE MANIPULATOR

(71) Applicant: Zhejiang Haozhonghao Health Product Co., Ltd., Wenzhou (CN)

(72) Inventors: Guohai ZHOU, Wenzhou (CN); Qing CHEN, Wenzhou (CN); Xingzhong FENG, Wenzhou (CN)

(73) Assignee: Zhejiang Haozhonghao Health Product Co., Ltd., Wenzhou (CN)

(21) Appl. No.: 18/593,072

(22) Filed: Mar. 1, 2024

(30) Foreign Application Priority Data
Apr. 28, 2023 (CN) 202310480012.8

(51) Int. Cl. A61H 7/00

(52) U.S. Cl. CPC A61H 7/007; A61H 2201/0149; A61H 2201/1215

(57) ABSTRACT

A self-balancing massage manipulator includes a mounting frame and a massage assembly, and the massage assembly includes an upper swing arm and an upper massage member; the self-balancing massage manipulator further includes an upper kneading shaft and a kneading motor, the upper kneading shaft has an upper eccentric structure driving the upper swing arm to swing, and the upper kneading shaft rotates to drive the upper swing arm to swing by the upper eccentric structure to effect kneading massage by the upper massage member; the self-balancing massage manipulator further includes a skeleton, and the mounting frame is swingably arranged on the skeleton; the self-balancing massage manipulator further includes a self-balancing buffer structure, and the self-balancing buffer structure includes a pull rod provided on the mounting frame and an elastic member with one end pulled on the pull rod.

### CROSS-REFERENCE TO RELATED APPLICATIONS

This application claims priority to Chinese Patent Application No. 202310480012.8, filed on Apr. 28, 2023, the content of which is incorporated herein by reference in its entirety.

### TECHNICAL FIELD

The present application relates to the field of massage chairs, in particular to a self-balancing massage manipulator.

### BACKGROUND

An existing massage chair includes a massage chair skeleton and a massage manipulator, the massage chair skeleton is provided with a guide rail, the massage manipulator includes a mounting frame, and the mounting frame is slidable up and down along the guide rail; the mounting frame is provided with a massage wheel assembly to massage a human body, a kneading assembly driving the massage wheel assembly to knead, and a knocking assembly driving the massage wheel assembly to knock; and a walking assembly driving the mounting frame to move along the guide rail is provided between the mounting frame and the guide rail.

In the prior art, CN112773677A discloses the massage manipulator includes a stand and an upper massage assembly, the upper massage assembly includes an upper swing arm and an upper massage member, the upper massage member is mounted on the upper swing arm, the stand is further provided with an upper kneading transmission mechanism driving the upper swing arm to cooperate with the upper massage member in a kneading action, the upper kneading transmission mechanism includes an upper kneading shaft and an upper kneading motor, the upper kneading shaft is rotatably arranged on the stand, the upper kneading motor drives the upper kneading shaft to rotate, the upper swing arm is sheathed on the upper kneading shaft, the upper kneading shaft drives the upper swing arm to swing, the stand is provided with a knocking transmission mechanism driving a knocking action of the upper swing arm, the knocking transmission mechanism is mounted on the stand by a slider, the slider is slidably arranged on the stand in a direction perpendicular to a kneading axis, and the slider is slidable on the stand under the action of the upper massage member; the stand is provided with a reset member drive the slider to reset slidably; and the massage manipulator enables adaptive adjustment by relative swing of the upper massage member. However, there are at least the following disadvantages: 1. self-adaptation is achieved by the swing of the upper massage member itself which results in a relatively small rotatable angle and has limitations; 2. an internal assembly space of a massager core is relatively compact in nature, and it is also necessary to provide a space for the slider to slide, and then the slider is driven to reset by a spring, which further compresses the internal assembly space, and results in inconvenience in assembly; 3. the spring is prone to aging after long-term use, and mounting the spring inside results in inconvenient maintenance; and 4. a knocking mechanism will be driven to move independently, which results in poor stability during assembly and relatively short service life.

### SUMMARY

In order to overcome the disadvantages of the prior art, the present application provides a self-balancing massage manipulator which effects adaptive adjustment by providing a massage assembly on a mounting frame as a whole followed by relative rotation of the mounting frame and reset of an elastic member, which results in a relatively large adjustable angle thereof, and mounting the elastic member outside facilitates maintenance and releases an internal assembly space.

The present application relates to a self-balancing massage manipulator which includes a mounting frame having a massage assembly; the massage assembly includes an upper swing arm, an upper massage member provided on the upper swing arm, an upper kneading shaft rotatably provided on the mounting frame, an upper kneading motor driving the upper kneading shaft to rotate, a lower swing arm, a lower massage member, a lower kneading shaft rotatably provided on the mounting frame, and a lower kneading motor driving the lower kneading shaft to rotate; the upper kneading shaft is arranged through the upper swing arm and has an upper eccentric structure driving the upper swing arm to swing; the upper kneading shaft rotates to drive the upper swing arm to swing by the upper eccentric structure to effect kneading massage by the upper massage member; the lower kneading shaft is arranged through the lower swing arm and has a lower eccentric structure driving the lower swing arm to swing; the lower kneading shaft rotates to drive the lower swing arm to swing by the lower eccentric structure to effect kneading massage by the lower massage member; wherein the self-balancing massage manipulator further includes a skeleton for the mounting frame to be rotatably hinged and a self-balancing buffer structure which is self-adaptive when the mounting frame swings; the skeleton is provided with an assembly space, and the mounting frame is rotatably arranged in the assembly space; the self-balancing buffer structure includes a pull rod provided on a side edge of the mounting frame and an elastic member with one end pulled on the pull rod; the skeleton is provided with a movable hole for the pull rod to penetrate through and move, the elastic member is located outside the skeleton, and the other end of the elastic member is pulled on the skeleton; and when the upper massage member is stressed, the mounting frame rotates, and the pull rod cooperates with the elastic member to form buffer and self-balance, and when the upper massage member is unstressed, the elastic member pulls the pull rod to reset the mounting frame.

With the above technical solution, during use, when a human body presses the upper massage member, pressure can act on the mounting frame, and in this case, the mounting frame is stressed to perform relative swing to effect self-adaptive and self-balancing adjustment of the mounting frame as a whole; and the lower massage member also swings upwards to abut against the human body, so that the upper massage member and the lower massage member abut against the skin simultaneously; and the elastic member is pulled on the pull rod to play a buffering role, which can improve comfort; when the pressure of the human body on the upper massage member disappears, the elastic member can also be pulled on the pull rod to reset the mounting frame, and during use, the upper kneading shaft and the upper kneading motor cooperate to separately drive the upper swing arm to swing, the lower kneading shaft and the lower kneading motor cooperate to separately drive the lower swing arm to swing, and the upper swing arm and the lower swing arm cooperate with each other to effect rubbing and kneading function. Since the upper kneading motor and the lower kneading motor can control movement separately, different combinations of movements can be changed according to customer needs, and self-adaptive adjustment is effected by arranging the massage assembly on the mounting frame as a whole followed by relative rotation of the mounting frame and reset of the elastic member, which results in a relatively large adjustable angle thereof, and mounting the elastic member outside the skeleton facilitates maintenance and replacement, and releases the internal assembly space.

A still further arrangement of the present application is as follows: the elastic member is a tension spring; the skeleton is provided with a tension spring column, and one end of the tension spring cooperating with the skeleton is pulled on the tension spring column; the mounting frame is provided with a hinging portion; and the hinging portion is hingedly arranged on the skeleton by a hinge shaft; and the hinging portion, the pull rod and the tension spring column form an included angle α, and the included angle α is 30-65 degrees.

With the above technical solution, it is only necessary to sheathe both ends of the tension spring on the pull rod and the tension spring column during assembly, which facilitates maintenance and replacement; it is not necessary to remove the massage assembly as a whole, and the included angle α is 30-65 degrees, so that the tension spring is inclined during assembly, and when the human body abuts against the upper massage member to swing along therewith, a reaction force of the tension spring is parallel or tends to be parallel to a resultant force (the resultant force is the force of the human body abutting against the upper massage member plus a force generated by the mounting frame due to own gravity), thereby reducing requirements for the tension spring.

A still further arrangement of the present application is as follows: the skeleton is provided with a limiting member for limiting a swinging angle thereof on a swinging track corresponding to the mounting frame, and the limiting member is made of an elastic material; and the limiting member includes a reverse limiting member limiting a counterclockwise rotation angle of the mounting frame and a forward limiting member limiting a clockwise rotation angle of the mounting frame.

With the above technical solution, it is possible to prevent an excessive rotation angle of the mounting frame, and use of the elastic material can also prevent hard collision, results in improved effect during use.

A still further arrangement of the present application is as follows: the upper swing arms are oppositely arranged in two groups, and the self-balancing massage manipulator further includes a knocking shaft rotatably provided on the mounting frame and a knocking motor driving the knocking shaft to rotate, the knocking shaft is provided with an eccentric portion, the eccentric portion is hingedly provided with a connecting rod, and one end of the connecting rod away from the eccentric portion linkedly cooperates with the upper swing arm by a universal joint to rotate the knocking shaft to drive the upper swing arm to knock.

With the above technical solution, the two groups of upper swing arms can increase a massage kneading area, and produce better effect in operation; when in use, the knocking motor can drive the knocking shaft to rotate, the eccentric portion on the knocking shaft can drive the connecting rod to extend and retract; and when the connecting rod extends and retracts, the upper swing arm can be driven by the universal joint to knock, and then a knocking massage function can be effected by the upper massage member.

A still further arrangement of the present application is as follows: the lower swing arms 20 are oppositely arranged in two groups.

With the above technical solution, the massage kneading area is increased, and the effect is improved in operation.

A still further arrangement of the present application is as follows: the self-balancing massage manipulator further includes a stand, the stand is provided with a walking shaft along a width direction thereof in a penetrating manner, the skeleton is rotatably arranged on the stand by the walking shaft, and the stand is further provided with a push-out shaft provided parallel to the walking shaft and a push-out motor driving the push-out shaft to rotate; and the self-balancing massage manipulator further includes a rack provided along a rotation track of the skeleton, the push-out shaft is provided with a gear meshing with the rack, and the gear rotates synchronously with the push-out shaft.

With the above technical solution, when the push-out motor drives the push-out shaft to rotate, the gear can be driven to rotate, and then the skeleton can be driven to rotate through cooperation of the gear and the rack to partially expose the stand, thus effecting overall angle adjustment of the skeleton.

A further arrangement of the present application is as follows: the skeleton includes two skeleton support sheet bodies and a skeleton connecting sheet body which connects the two skeleton support sheet bodies into one body, and the two support sheet bodies are provided with a hinge shaft in a penetrating manner; the mounting frame includes two mounting frame support sheet bodies and a mounting frame connecting sheet body which connects the two mounting frame support sheet bodies into one body; the two mounting frame support sheet bodies are located between the two skeleton support sheet bodies, and each of the two mounting frame support sheet bodies is hinged with a corresponding skeleton support sheet body by the hinge shaft; the self-balancing buffer structures are arranged in two groups; and the pull rod is arranged on a corresponding mounting frame support sheet body, the elastic member is arranged outside a corresponding skeleton support sheet body, and the movable hole is arranged on a corresponding skeleton support sheet body.

With the above technical solution, a more reasonable structural layout is obtained, which facilitates formation of the assembly space and mounting of the massage assembly, and the two groups of self-balancing buffer structures improve the effect and stability during the adaptive adjustment.

A further arrangement of the present application is as follows: the forward limiting member and the reverse limiting member are both provided with a snap-in groove, and the forward limiting member and the reverse limiting member are both arranged through the skeleton, and are snapped to the skeleton by the snap-in grooves.

With the above technical solution, a simple structure is obtained, which facilitates the assembly.

A further arrangement of the present application is as follows: the stand is further provided with a walking motor driving the walking shaft to rotate, and the walking shaft is sheathed with a walking wheel.

With the above technical solution, the walking shaft can be driven to rotate by the walking motor, and then the whole stand can walk on a massage chair by the walking wheel.

### BRIEF DESCRIPTION OF THE DRAWINGS

FIG. 1 is a schematic diagram of an overall structure of the present application.

FIG. 2 is a structural schematic diagram of a skeleton of the present application after being rotated.

FIG. 3 is a partial structural schematic diagram of the present application.

FIG. 4 is a schematic diagram of positions of an elastic buffer member and a self-balancing buffer structure of the present application.

FIG. 5 is a diagram showing cooperation of components on the skeleton of the present application.

FIG. 6 is a diagram showing cooperation of an upper swing arm, an upper massage member, a knocking shaft, a knocking motor, an upper kneading shaft, and an upper kneading motor and other components of the present application.

FIG. 7 is a diagram showing cooperation of the upper kneading shaft, the upper kneading motor, the upper swing arm and the upper massage member of the present application.

FIG. 8 is a diagram showing cooperation of a lower kneading shaft, a lower kneading motor, a lower swing arm and a lower massage member of the present application.

FIG. 9 is a structural schematic diagram of the elastic buffer member of the present application.

FIG. 10 is a schematic diagram of a force analysis of a mounting frame of the present application.

FIG. 11 is a schematic diagram of an included angle α of the present application.

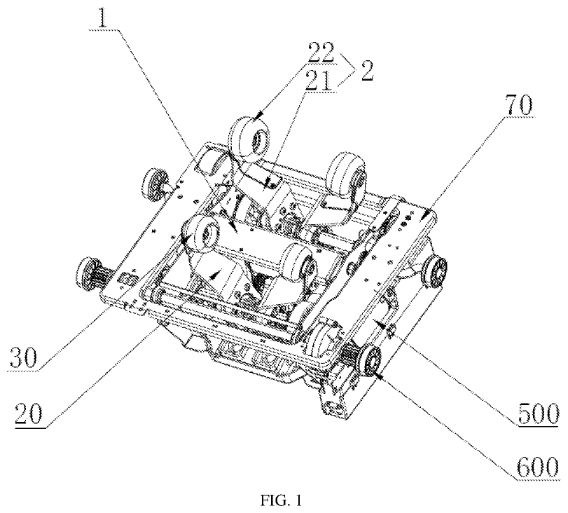

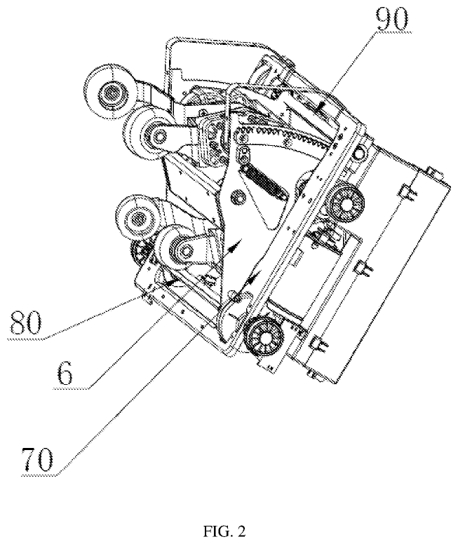

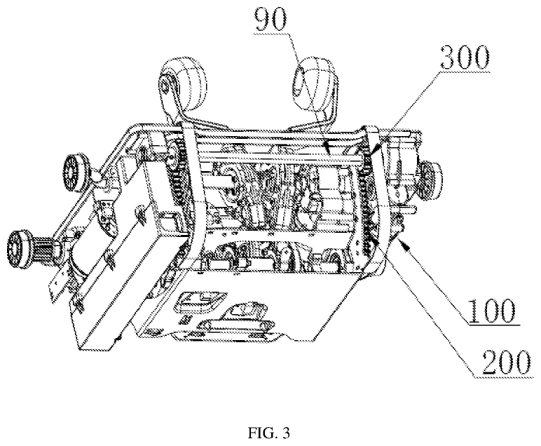

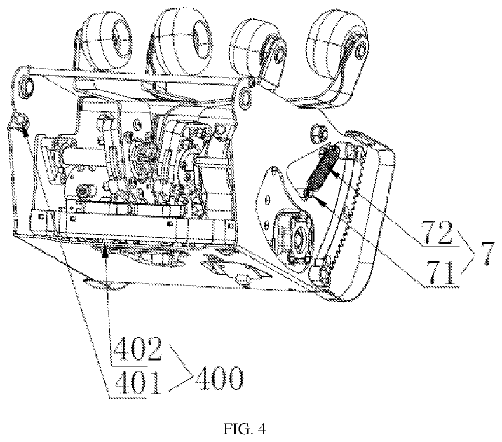

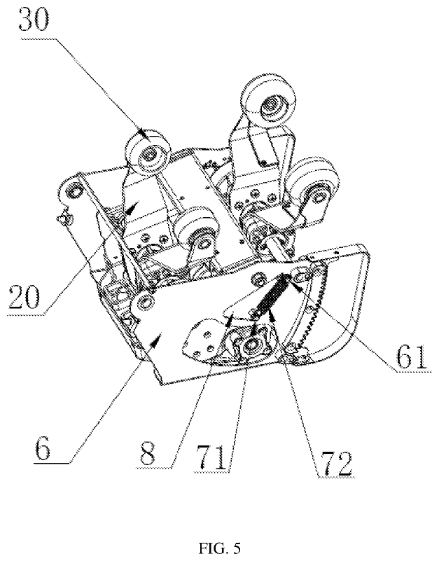

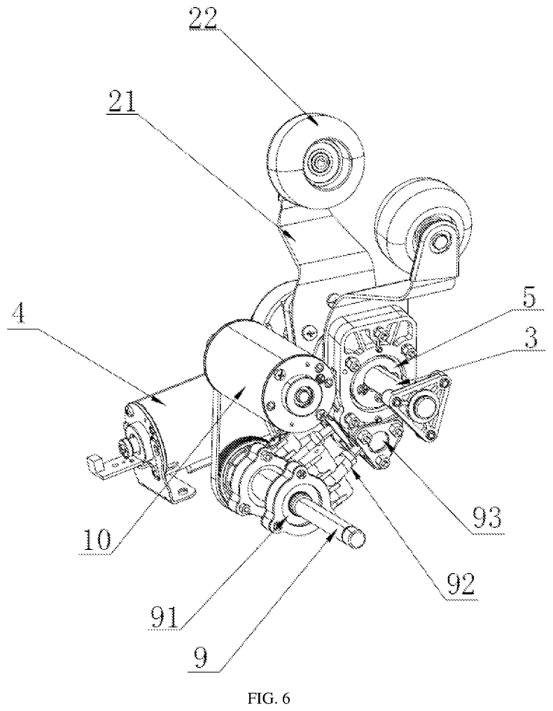

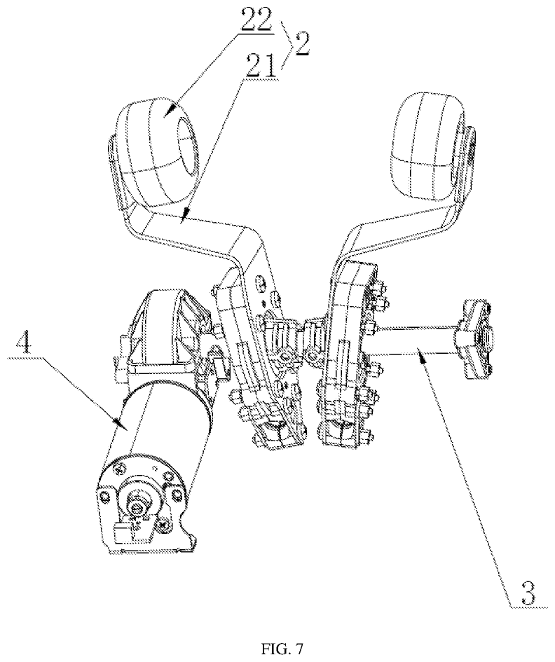

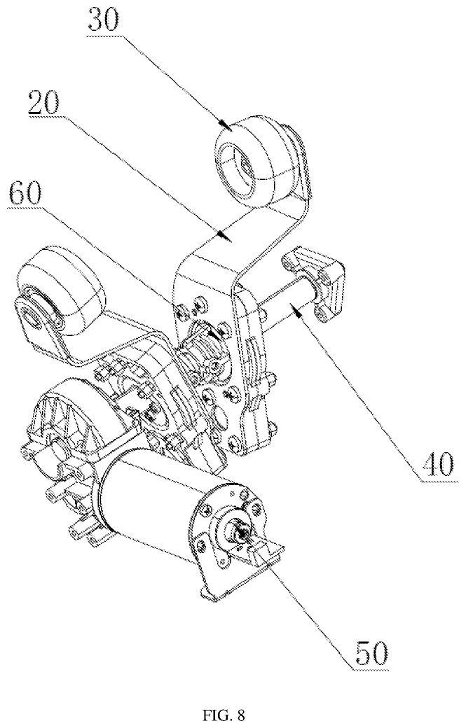

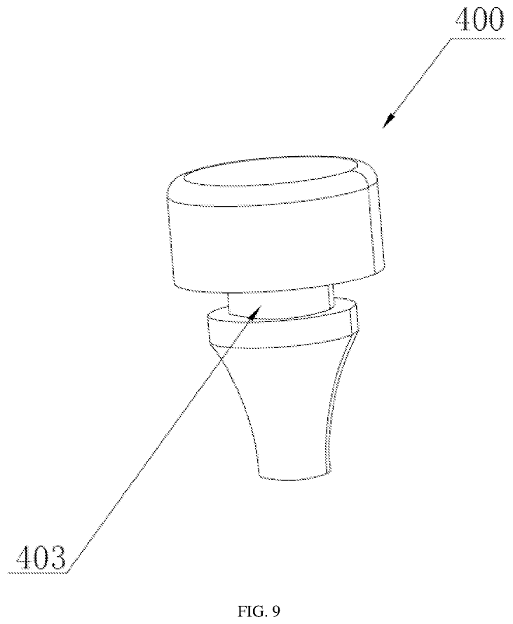

### DETAILED DESCRIPTION OF THE EMBODIMENTS

The specific embodiments of the present application are described in detail below with reference to the accompanying drawings:

In the description of the present application, it should be appreciated that the terms “upper”, “lower”, “bottom”, “top”, “front”, “rear”, “inner”, “outer”, “left”, “right” and the like indicate orientations or positional relationships based on the orientations or positional relationships shown in the drawings, and are only for convenience of description and simplification of description, but do not indicate or imply that the device or element to be referred must have a specific orientation, be constructed and be operated in a specific orientation, and thus, should not be construed as limiting the present application. It is common general knowledge of a person skilled in the art that both an upper eccentric structure and a lower eccentric structure each may be an eccentric sleeve or an eccentric wheel or a and bump, and the specific mounting means belong to common general knowledge of those skilled in the art, and will not be described in detail herein. Both an upper massage member and a lower massage member may be a massage head or a massage wheel.

The present application relates to a self-balancing massage manipulator including a mounting frame 1 having a massage assembly 2; the massage assembly 2 includes an upper swing arm 21, an upper massage member 22 provided on the upper swing arm 21, an upper kneading shaft 3 rotatably provided on the mounting frame 1 and an upper kneading motor 4 driving the upper kneading shaft 3 to rotate; the upper kneading shaft 3 is arranged through the upper swing arm 21 and has an upper eccentric structure 5 driving the upper swing arm 21 to swing; the upper kneading shaft 3 rotates to drive the upper swing arm 21 to swing by the upper eccentric structure 5 to effect kneading massage by the upper massage member 22; the self-balancing massage manipulator further includes a lower swing arm 20 having a lower massage member 30, and further includes a lower kneading shaft 40 rotatably arranged on the mounting frame 1 and a lower kneading motor 50 driving the lower kneading shaft 40 to rotate; the lower kneading shaft 40 is arranged through the lower swing arm 20 and has a lower eccentric structure 60 driving the lower swing arm 20 to swing; the lower kneading shaft 40 rotates to drive the lower swing arm 20 to swing by the lower eccentric structure 60 to effect kneading massage by the lower massage member 30 (when the lower massage member 30 swings, the lower swing arm 20 is most preferably limited by a ball head limiting member, specifically, ball heads are provided at both ends of a connecting rod, one ball head is arranged on the lower swing arm 20, and the other ball head is arranged on the mounting frame 1, and the principle thereof is the same as that of a universal joint ball head and is not described in detail herein, so that the lower massage member 30 is more stable when massaging); and the upper kneading shaft 3 and the upper kneading motor 4 cooperate to separately drive the upper swing arm 21 to swing, the lower kneading shaft 40 and the lower kneading motor 50 cooperate to separately drive the lower swing arm 20 to swing, and the upper swing arm 21 and the lower swing arm 20 cooperate with each other to effect rubbing and kneading function. Since the upper kneading motor 4 and the lower kneading motor 50 can control movement separately, different combinations of movements can be changed according to customer needs, and the specific control belongs to the common general knowledge of those skilled in the art and will not be described in detail herein. In an embodiment of the present application, the self-balancing massage manipulator further includes a skeleton 6 for the mounting frame 1 to be rotatably hinged and a self-balancing buffer structure 7 which is self-adaptive when the mounting frame 1 swings; the skeleton 6 is provided with an assembly space, and the mounting frame 1 is rotatably arranged in the assembly space; the self-balancing buffer structure 7 includes a pull rod 71 provided on the mounting frame 1 and an elastic member 72 with one end pulled on the pull rod 71; the skeleton 6 is provided with a movable hole 8 for the pull rod 71 to penetrate through and move, the elastic member 72 is located outside the skeleton 6, and the other end of the elastic member 72 is pulled on the skeleton 6; when a human body presses the upper massage member 22, pressure can act on the mounting frame 1, in this case, the mounting frame 1 is stressed to perform relative swing, in this case, the lower massage member 30 also swings upwards to abut against the human body, so that the upper massage member 22 and the lower massage member 30 abut against the skin simultaneously, and the elastic member 72 is pulled on the pull rod 71 to play a buffering role, which can improve comfort; when the pressure of the human body on the upper massage member 22 disappears, the elastic member 72 can also be pulled on the pull rod 71 to reset the mounting frame 1; and self-adaptive adjustment is effected by arranging the massage assembly 2 on the mounting frame 1 as a whole followed by relative rotation of the mounting frame 1 and reset of the elastic member 72, which results in a relatively large adjustable angle thereof, and mounting the elastic member 72 outside facilitates maintenance and replacement, and releases the internal assembly space.

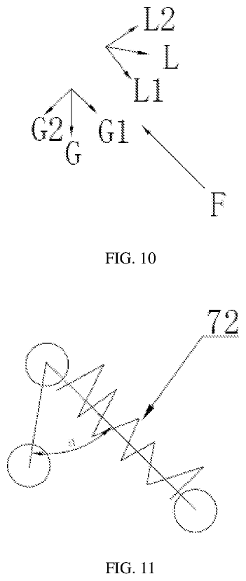

The elastic member 72 is a tension spring; the skeleton 6 is provided with a tension spring column 61, and one end of the tension spring cooperating with the skeleton 6 is pulled on the tension spring column 61; the mounting frame 1 is provided with a hinging portion, and the hinging portion is hingedly arranged on the skeleton 6 by a hinge shaft; and the hinging portion, the pull rod 71 and the tension spring column 61 form an included angle α, and the included angle α is 30-65 degrees; it is only necessary to sheathe both ends of the tension spring on the pull rod 71 and the tension spring column 61 during assembly, which facilitates maintenance and replacement; it is not necessary to remove the massage assembly 2 as a whole, and the included angle α is 30-60 degrees, so that the tension spring is inclined during assembly; and when the human body abuts against the upper massage member 22 to swing along therewith, a reaction force of the tension spring is parallel or tends to be parallel to a resultant force (the resultant force is the force of the human body abutting against the upper massage member 22 plus a force generated by the mounting frame 1 due to own gravity, as shown in FIG. 10, G is the overall gravity on the mounting frame 1, L is the force of the human body abutting against the upper massage member, F is an elastic force of the elastic member, and L1 and G1 are combined into the resultant force), thus reducing requirements for the tension spring.

The skeleton 6 is provided with a limiting member 400 for limiting a swinging angle thereof on a swinging track corresponding to the mounting frame 1, and the limiting member 400 is made of an elastic material (rubber, plastic, silicone, Kraft, etc. may be used); and the limiting member 400 includes a reverse limiting member 402 limiting a counterclockwise rotation angle of the mounting frame 1 and a forward limiting member 401 limiting a clockwise rotation angle of the mounting frame 1, which can prevent an excessive rotation angle of the mounting frame 1, and use of the elastic material can also prevent hard collision, results in improved effect during use.

The upper swing arms 21 are oppositely arranged in two groups, and the self-balancing massage manipulator further includes a knocking shaft 9 rotatably provided on the mounting frame 1 and a knocking motor 10 driving the knocking shaft 9 to rotate, the knocking shaft 9 is provided with an eccentric portion 91, the eccentric portion 91 is hingedly provided with a connecting rod 92, and one end of the connecting rod 92 away from the eccentric portion 91 linkedly cooperates with the upper swing arm 21 by a universal joint 93 to rotate the knocking shaft 9 to drive the upper swing arm 21 to knock, and when in use, the knocking motor 10 can drive the knocking shaft 9 to rotate, the eccentric portion 91 on the knocking shaft 9 can drive the connecting rod 92 to extend and retract; and when the connecting rod 92 extends and retracts, the upper swing arm 21 can be driven by the universal joint 93 to knock, and then a knocking massage function can be effected by the upper massage member 22.

The self-balancing massage manipulator further includes a stand 70, the stand 70 is provided with a walking shaft 80 along a width direction thereof in a penetrating manner, the skeleton 6 is rotatably arranged on the stand 70 by the walking shaft 80, and the stand 70 is further provided with a push-out shaft 90 provided parallel to the walking shaft 80 and a push-out motor 100 driving the push-out shaft 90 to rotate; and the self-balancing massage manipulator further includes a rack 200 provided along a rotation track of the skeleton 6, the push-out shaft 90 is provided with a gear 300 meshing with the rack 200, and the gear 300 rotates synchronously with the push-out shaft 90; when the push-out motor 100 drives the push-out shaft 90 to rotate, the gear 300 can be driven to rotate, and then the skeleton 6 can be driven to rotate through cooperation of the gear 300 and the rack 200 to partially expose the stand 70, thus effecting overall angle adjustment of the skeleton 6; and the skeleton 6 acts both as a support frame for the mounting frame 1 and as an angle adjusting frame for the mounting frame 1, having multiple effects.

The skeleton 6 includes two skeleton support sheet bodies and a skeleton connecting sheet body which connects the two skeleton support sheet bodies into one body, and the two support sheet bodies are provided with a hinge shaft in a penetrating manner; the mounting frame 1 includes two mounting frame support sheet bodies and a mounting frame connecting sheet body which connects the two mounting frame support sheet bodies into one body; the two mounting frame support sheet bodies are located between the two skeleton support sheet bodies, and each of the two mounting frame support sheet bodies is hinged with a corresponding skeleton support sheet body by the hinge shaft; and the self-balancing buffer structures 7 are arranged in two groups, the pull rod 71 is arranged on a corresponding mounting frame support sheet body, the elastic member 72 is arranged outside a corresponding skeleton support sheet body, and the movable hole 8 is arranged on a corresponding skeleton support sheet body, which result in a more reasonable structural layout, and facilitate formation of the assembly space and mounting of the massage assembly 2, and the two groups of self-balancing buffer structures 7 improve the effect and stability during the adaptive adjustment.

The forward limiting member and the reverse limiting member are both provided with a snap-in groove 403, and the forward limiting member and the reverse limiting member are both arranged through the skeleton 6, and are snapped to the skeleton 6 by the snap-in grooves 403, which result in a simple structure and facilitate the assembly.

The stand 70 is further provided with a walking motor 500 driving the walking shaft 80 to rotate, and the walking shaft 80 is sheathed with a walking wheel 600 rotating synchronously therewith, the walking shaft 80 can be driven to rotate by the walking motor 500, and then the whole stand 70 can walk on a massage chair by the walking wheel 600.

What is claimed is:

1. A self-balancing massage manipulator, comprising a mounting frame having a massage assembly;
the massage assembly comprising an upper swing arm, an upper massage member provided on the upper swing arm, an upper kneading shaft rotatably provided on the mounting frame, an upper kneading motor driving the upper kneading shaft to rotate, a lower swing arm, a lower massage member, a lower kneading shaft rotatably provided on the mounting frame, and a lower kneading motor driving the lower kneading shaft to rotate;
the upper kneading shaft being arranged through the upper swing arm and having an upper eccentric structure driving the upper swing arm to swing; the upper kneading shaft rotating to drive the upper swing arm to swing by the upper eccentric structure to effect kneading massage by the upper massage member;
the lower kneading shaft being arranged through the lower swing arm and having a lower eccentric structure driving the lower swing arm to swing; the lower kneading shaft rotating to drive the lower swing arm to swing by the lower eccentric structure to effect kneading massage by the lower massage member;
wherein the self-balancing massage manipulator further comprises a skeleton for the mounting frame to be rotatably hinged and a self-balancing buffer structure which is self-adaptive when the mounting frame swings;
the skeleton being provided with an assembly space, and the mounting frame being rotatably arranged in the assembly space; the self-balancing buffer structure comprising a pull rod provided on a side edge of the mounting frame and an elastic member with one end pulled on the pull rod; the skeleton being provided with a movable hole for the pull rod to penetrate through and move, the elastic member being located outside the skeleton, and the other end of the elastic member being pulled on the skeleton; and when the upper massage member being stressed, the mounting frame rotating, and the pull rod cooperating with the elastic member to form buffer and self-balance, and when the upper massage member being unstressed, the elastic member pulling the pull rod to reset the mounting frame.

2. The self-balancing massage manipulator according to claim 1, wherein the elastic member is a tension spring; the skeleton is provided with a tension spring column, and one end of the tension spring cooperating with the skeleton is pulled on the tension spring column; the mounting frame is provided with a hinging portion; the hinging portion is hingedly arranged on the skeleton by a hinge shaft; and the hinging portion, the pull rod and the tension spring column form an included angle α, and the included angle α is 30-65 degrees.

3. The self-balancing massage manipulator according to claim 1, wherein the skeleton is provided with a limiting member for limiting a swinging angle thereof on a swinging track corresponding to the mounting frame, and the limiting member is made of an elastic material.

4. The self-balancing massage manipulator according to claim 3, wherein the limiting member comprises a reverse limiting member limiting a counterclockwise rotation angle of the mounting frame and a forward limiting member limiting a clockwise rotation angle of the mounting frame.

5. The self-balancing massage manipulator according to claim 4, wherein the upper swing arms are oppositely arranged in two groups, and the self-balancing massage manipulator further comprises a knocking shaft rotatably provided on the mounting frame and a knocking motor driving the knocking shaft to rotate, the knocking shaft is provided with an eccentric portion, the eccentric portion is hingedly provided with a connecting rod, and one end of the connecting rod away from the eccentric portion linkedly cooperates with the upper swing arm by a universal joint to rotate the knocking shaft to drive the upper swing arm to knock.

6. The self-balancing massage manipulator according to claim 4, further comprising a stand, and a walking shaft provided along a width direction of the stand, wherein the skeleton is rotatably arranged on the stand by the walking shaft, and the stand is further provided with a push-out shaft provided parallel to the walking shaft and a push-out motor driving the push-out shaft to rotate; and further comprising a rack provided along a rotation track of the skeleton, wherein the push-out shaft is provided with a gear meshing with the rack, and the gear rotates synchronously with the push-out shaft.

7. The self-balancing massage manipulator according to claim 6, wherein the lower swing arms are oppositely arranged in two groups.

8. The self-balancing massage manipulator according to claim 7, wherein the skeleton comprises two skeleton support sheet bodies and a skeleton connecting sheet body which connects the two skeleton support sheet bodies into one body, and the two skeleton support sheet bodies are provided with a hinge shaft in a penetrating manner; the mounting frame comprises two mounting frame support sheet bodies and a mounting frame connecting sheet body which connects the two mounting frame support sheet bodies into one body; the two mounting frame support sheet bodies are located between the two skeleton support sheet bodies, and each of the two mounting frame support sheet bodies is hinged with a corresponding skeleton support sheet body by the hinge shaft; the self-balancing buffer structures are arranged in two groups; and the pull rod is arranged on a corresponding mounting frame support sheet body, the elastic member is arranged outside a corresponding skeleton support sheet body, and the movable hole is arranged on a corresponding skeleton support sheet body.

9. The self-balancing massage manipulator according to claim 7, wherein the reverse limiting member and the forward limiting member are both provided with a snap-in groove, and the reverse limiting member and the forward limiting member are both arranged through the skeleton, and are snapped to the skeleton by the snap-in grooves.

10. The self-balancing massage manipulator according to claim 9, wherein the stand is further provided with a walking motor driving the walking shaft to rotate, and the walking shaft is sheathed with a walking wheel.
